(19) United States
(12) Patent Application Publication
(10) Pub. No.: US 2025/0040602 A1
(43) Pub. Date: Feb. 6, 2025

(54) Aerosol Generating System with Improved Wicking

(71) Applicant: JT International S.A., Geneva (CH)

(72) Inventors: Jaakko McEvoy, Vienna (AT); Christoph Lungenschmied, Vienna (AT); Madoka Hasegawa, Nyon (CH)

(73) Assignee: JT International S.A., Geneva (CH)

(21) Appl. No.: 18/717,744

(22) PCT Filed: Dec. 13, 2022
(86) PCT No.: PCT/EP2022/085614

§ 371 Date: Jun. 7, 2024

(30) Foreign Application Priority Data
Dec. 14, 2021 (EP) 21214424.0

(51) Int. Cl. A24F 40/44; A24F 40/10; A24F 40/42; B06B 1/06

(52) U.S. Cl. CPC A24F 40/44; A24F 40/10; A24F 40/42; B06B 1/0603; B06B 2201/77

(57) ABSTRACT

An aerosol generating system includes:
a storage compartment including a liquid aerosol-forming material;
a wick element forming a wick body and arranged in fluid communication with the storage compartment; the wick body being formed by:
a group of flowable solid particles; or
a porous solid monolithic element;
a heater; and
a vibrating element configured to generate excitation waves inside the wick element to create or enhance wicking from the storage compartment to the heater.

### FIELD OF THE INVENTION

The present invention concerns an aerosol generating system with improved wicking.

### BACKGROUND OF THE INVENTION

Different types of aerosol generating systems are already known in the art. Generally, such systems comprise a storage compartment for storing a liquid aerosol forming precursor. A heating system is formed of one or more electrically activated resistive heating elements arranged to heat said precursor to generate the aerosol. A wick element in fluid communication with the storage compartment enables to provide the liquid aerosol forming precursor to the heating system. The aerosol is released into a flow path extending between an inlet and outlet of the device. The outlet may be arranged as a mouthpiece, through which a user inhales for delivery of the aerosol.

However, most of the known aerosol generating systems do not allow a precise control of the wicking rate. In particular, a too low wicking rate may result in dry puffs, while a too large wicking rate may contribute to unwanted leakage, which deteriorate the user experience.

It would also be desirable to improve the heat transfer from the heating element to the liquid, which would result in a more efficient evaporation process, ultimately improving the energy efficiency of the entire device.

### SUMMARY OF THE INVENTION

One of the aims of the present invention is to provide an aerosol generating system which solves the above-mentioned issues. Particularly, the system according to the invention aims to improve the wicking from the storage compartment towards the heater.

For this purpose, the invention concerns an aerosol generating system comprising:
a storage compartment comprising a liquid aerosol-forming material;
a wick element forming a wick body and arranged in fluid communication with the storage compartment; the wick body being formed by:
   a group of flowable solid particles; or
   a porous solid monolithic element;
a heater;
a vibrating element configured to generate excitation waves inside the wick element to create or enhance wicking from the storage compartment to the heater.

Using these features, the aerosol generating system according to the invention ensures a precise control of the wicking rate and an enhanced heat transfer. In particular, without wishing to be bound by theory, the excitation waves generated by the vibrating element result in the thinning or even the destruction of the thermal boundary layer at the liquid/solid interface between the liquid aerosol-forming material and the heater, ensuring a better heat transfer.

Moreover, the vibrations enable to increase the nucleation rate and delay film boiling around the heater, allowing the system to reach higher critical heat fluxes.

Vibrations furthermore induce fluid shear forces resulting in viscous heating in the liquid aerosol-forming material and a reduction in viscosity.

According to some embodiments, said excitation waves are infrasonic, ultrasonic or sonic waves.

According to some embodiments, the vibrating element is configured to generate said excitation waves with an excitation frequency comprised between 0.5 Hz and 60 kHz, preferably between 10 Hz to 60 KHz and more preferably 20 KHz to 40 KHz.

The range of excitation frequency comprised between 0.5 Hz and 60 KHz enables sufficient vibrations to ensure an efficient wicking. The excitation frequency and amplitude may be adjusted by variation of the input power to the excitation source, providing real-time control of the heat transfer enhancement and wicking rate.

According to some embodiments, the vibrating element is arranged adjacent to the wick body.

By implementing this feature, the position of the vibrating element relative to the wick body enables an efficient transmission of the generated excitation waves to the wick body.

According to some embodiments, the aerosol generating system further comprises a connecting element connecting the vibrating element and the wick body, and configured to transmit excitation waves from the vibrating element to the wick body.

By implementing this feature, the vibrating element does not need to be in direct contact with the wick body, allowing for the vibrating element to be arranged somewhere else in the device, but for the resultant excitation output to be delivered to the desired location, namely the wick body. As an example, a piezo ceramic ring bender element with a fixed piston can be located in the device body, with the end of the piston being in communication with the wick body.

According to some embodiments, the vibrating element forms a unidirectional source of excitation waves.

By implementing this feature, the excitation is focused in a specific direction within the fluid providing a net forward flow velocity in said direction, improving the liquid flow and the wicking. This phenomenon is called acoustic streaming.

According to some embodiments, the vibrating element forms an omnidirectional source of excitation waves.

According to some embodiments, the aerosol generating system comprises at least two vibrating elements.

According to some embodiments, the vibrating elements are distributed evenly around the wick body.

The wick body may be excited with no specific focused direction of excitation by one or more excitation sources being in indirect or direct communication with the wick body.

According to some embodiments, the wick body is a group of flowable solid particles. For example, the group of flowable solid particles is formed of loosely-packed solid particles. Alternatively, the group of flowable solid particles is formed of a liquid permeable pouch having an interior volume and loosely-packed solid particles stored within the interior volume of the liquid permeable pouch.

According to some embodiments, the storage compartment is formed at least partially by the liquid permeable pouch, the liquid aerosol forming material being retained inside the pouch in the interstices of the solid particles and/or on their surfaces.

By implementing these features, the solid particles are packed densely together in the pouch ensuring that there is low wicking rate due to the small hydraulic diameters between the particles in absence of excitation waves. When the vibrating element generates excitation waves, these waves force the particles to oscillate and cause liquefaction of the agglomeration of particles. The hydraulic diameters of the capillary channels defined by the particles tend to become larger as a result of liquefaction, allowing for enhanced liquid flow through the capillary channels of the wick body.

According to some embodiments, the liquid permeable pouch is at least partially wrapped in an impermeable wrapper.

By implementing this feature, the pouch is coated in an impermeable material preventing unwanted leakage of liquid when the consumable is not in use.

According to some embodiments, the wrapper is configured to be removed before operating the system to generate aerosol or to form an opening while operating the system to generate aerosol.

By implementing this feature, the wrapper may be removed before inserting the liquid consumable into the device. Alternatively, the wrapper may consist of a material that only enables fluid flow once the consumable is brought in contact with the heater. The heat may introduce a change in wettability or the wrapper may be a wax, melting at elevated temperatures.

According to some embodiments, the wick body is a porous solid monolithic element made of porous ceramic material.

According to some embodiments, the porous ceramic material is aluminum oxide, zirconia, or silicon nitride.

The invention also concerns a method of operating an aerosol generating system comprising steps of:
providing an aerosol generating system according to any one of the preceding claims;
operating simultaneously the heater to generate heat for evaporating the liquid aerosol forming material delivered from the storage compartment to a surface of the heater through the wick element and the vibrating element to generate excitation waves inside the wick element.

### BRIEF DESCRIPTION OF THE DRAWINGS

The invention and its advantages will be better understood upon reading the following description, which is given solely by way of non-limiting example and which is made with reference to the appended drawings, in which:

FIG. 1 is a schematic view of an aerosol generating system according to the invention comprising a wick element;

FIG. 2 is a schematic view of the wick element of FIG. 1 according to a first embodiment;

FIG. 3 is a schematic view of the wick element of FIG. 1 according to a second embodiment;

FIG. 4 is a schematic view of the wick element of FIG. 1 according to a third embodiment;

FIG. 5 is a schematic view of the wick element of FIG. 1 according to a fourth embodiment; and

FIG. 6 is a schematic view of the wick element of FIG. 1 according to a fifth embodiment.

### DETAILED DESCRIPTION OF THE INVENTION

Before describing the invention, it is to be understood that it is not limited to the details of construction set forth in the following description. It will be apparent to those skilled in the art having the benefit of the present disclosure that the invention is capable of other embodiments and of being practiced or being carried out in various ways.

As used herein, the term “aerosol generating device” or “device” may include a vaping device to deliver an aerosol to a user, including an aerosol for vaping, by means of aerosol generating unit (e.g. an aerosol generating element which generates vapor which condenses into an aerosol before delivery to an outlet of the device at, for example, a mouthpiece, for inhalation by a user). The device may be portable. “Portable” may refer to the device being for use when held by a user. The device may be adapted to generate a variable amount of aerosol, e.g. by activating a heater system for a variable amount of time (as opposed to a metered dose of aerosol), which can be controlled by a trigger. The trigger may be user activated, such as a vaping button and/or inhalation sensor. The inhalation sensor may be sensitive to the strength of inhalation as well as the duration of inhalation to enable a variable amount of vapor to be provided (so as to mimic the effect of smoking a conventional combustible smoking article such as a cigarette, cigar or pipe, etc.). The device may include a temperature regulation control to drive the temperature of the heater and/or the heated aerosol generating substance (aerosol pre-cursor) to a specified target temperature and thereafter to maintain the temperature at the target temperature that enables efficient generation of aerosol.

As used herein, the term “aerosol” may include a suspension of precursor as one or more of: solid particles; liquid droplets; gas. Said suspension may be in a gas including air. Aerosol herein may generally refer to/include a vapor. Aerosol may include one or more components of the precursor.

As used herein, the term “liquid aerosol forming material” or “aerosol forming precursor” or “precursor” or “aerosol forming substance” or “substance” or “vaporizable material” is used to designate any material that is vaporizable in air to form aerosol. Vaporisation is generally obtained by a temperature increase up to the boiling point of the vaporization material, such as at a temperature up to 400° C., preferably up to 350° C. The vaporizable material may, for example, comprise or consist of an aerosol-generating liquid, gel, or wax or the like or an aerosol-generating solid that may be in the form of a rod, which contains processed tobacco material, a crimped sheet or oriented strips or shreds of reconstituted tobacco (RTB), or any combination of these. The vaporizable material may comprise one or more of: nicotine; caffeine or other active components. The active component may be carried with a carrier, which may be a liquid aerosol forming agent. The carrier may include propylene glycol or glycerin or a combination thereof. A flavoring may also be present. The flavoring may include Ethylvanillin (vanilla), menthol, Isoamyl acetate (banana oil) or similar.

### DESCRIPTION OF A FIRST EMBODIMENT OF THE INVENTION

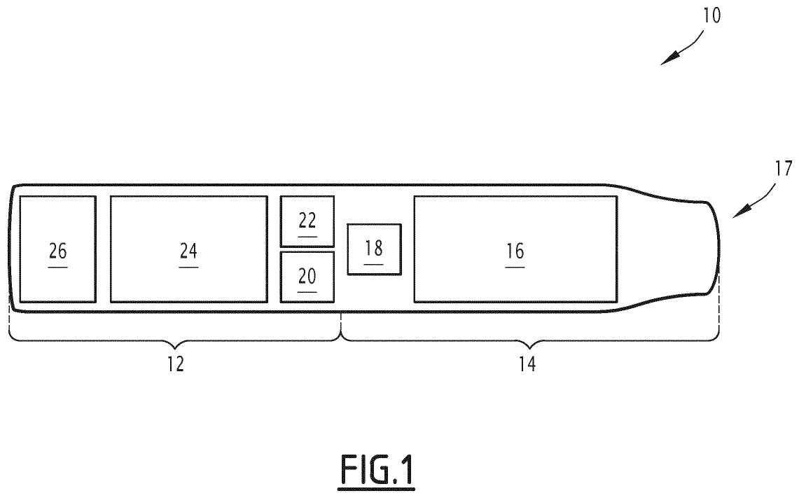

FIG. 1 shows an aerosol generating system 10 according to a first embodiment of the invention comprising an aerosol generating device 12 and a cartridge 14.

The aerosol generating device 12 is configured to operate with the cartridge 14. In particular, the aerosol generating device 12 comprises a device body defining a cavity configured to receive the cartridge 14. The cartridge 14 and the aerosol generating device 12 may be detachably engaged in a functioning relationship. Various mechanisms may be used to connect the cartridge and the aerosol generating device that include a threaded engagement, a press-fit engagement, an interference fit, a magnetic engagement, or the like. In a variant, the cartridge 14 may be fixed permanently to the device 12. The aerosol delivery system 10 may be substantially rod-like shaped, as shown on FIG. 1.

In reference to FIG. 1, the aerosol generating system 10 comprises a storage compartment 16. The storage compartment 16 is arranged in the cartridge 14. The storage compartment 16 comprises a liquid aerosol forming material. In a variant (not-shown), the storage comportment 16 is integrated in the device 12 and can be refilled by the user. In this case, no cartridge is necessary to operate with the device 12.

The cartridge 14 may comprise a mouthpiece 17 arranged at the downstream end of the cartridge 14. “Downstream” and “upstream” are defined with reference to an airflow flowing out of the cartridge 14. The mouthpiece 17 defines at least one airflow channel comprising at least one air outlet. The mouthpiece 17 may be attached on the distal end of the cartridge 14 or may be a part of the cartridge 14. In use, a user may draw the air from the mouthpiece to cause the air to flow into the aerosol generating system 10 from an air inlet of the aerosol generating device 12 through the cartridge 14.

In reference to FIG. 1, the aerosol generating system 10 further comprises a wick element 18, a heater 20, a vibrating element 22, a power supply 24 and a controller 26.

The heater 20 is configured to evaporate the liquid aerosol forming material from the storage compartment 16 when the aerosol generating device 12 is operated to generate aerosol. The heater 20 is formed of one or more electrically activated resistive heating elements arranged to heat the liquid aerosol forming material to generate the aerosol. In a variant, the heater 20 may be an induction heater.

The heater 20 is connected electrically to the power supply 24 located in the aerosol generating device 12, for example through a pair of contacts arranged in both cartridge 14 and aerosol generation device 12. According to another embodiment of the invention, the heater 20 may be coupled with a heating element arranged in the device 12 and powered by the power supply 24 of this device 12. In this case, heat is transmitted directly from the heater of the device 12 to the heater of the cartridge 14.

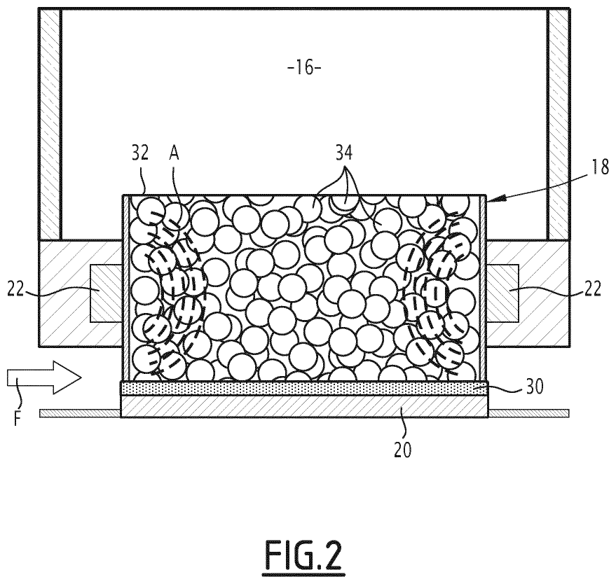

The wick element 18 is arranged in fluid communication with the storage compartment 16. The wick element 18 is an interface between the storage compartment 16 and the heater 20. In particular, the wick element 18 is configured to regulate the providing of liquid aerosol forming material towards the heater 20. In reference to FIG. 2, the wick element 18 provides the liquid aerosol forming material towards a porous membrane 30. The porous membrane 30 forms a mechanical interface between the wick element 18 and the heater 20. The heater 20 is able to heat the liquid aerosol forming material present in the porous membrane 30. The generated aerosol is mixing with the airflow, represented by the arrow F on FIG. 2, coming from an air inlet arranged in the device 12 and flowing through the membrane 30 in direction of the mouthpiece 17 to provide the generated aerosol to the user.

The wick element 18 forms a wick body. The wick body is here formed of a group of flowable solid particles. The group of flowable solid particles comprises loosely-packed solid particles 34.

In particular, as visible on FIG. 2, the wick body is formed by a liquid permeable pouch 32 having an interior volume. The interior volume is filled with a liquid retention medium. The liquid retention medium comprises loosely-packed solid particles 34 stored within the interior volume of the liquid permeable pouch 32.

Alternatively, the wick body is directly formed by the loosely-packed solid particles 34, without a pouch. Said particles 34 are kept within an interior space integrated in a housing of the cartridge 14. For example, a part of the housing of the cartridge 14 defines a compartment for receiving the loosely-packed solid particles 34. Said compartment may comprise a first liquid permeable part to receive the aerosol-forming material from the storage compartment 16 and a second liquid permeable part to deliver the aerosol-forming material from the wick body to the porous membrane 30. The second liquid permeable part may be the porous membrane 30.

The loosely-packed particles 34 are a granular material which is a conglomeration (or an aggregation) of small solid particles. When the particles 34 are wet by liquid, microscopic liquid bridges are formed in interstices of adjacent particles and the capillary force of the liquid bridges keeps the aggregated particles together. The network of particles 34 is therefore flexible, and it is reorganizable when mechanical stress is applied.

Preferably, the loosely-packed solid particles 34 comprise particles with maximum dimension comprised between 0.05 mm and 2 mm. For example, the maximum dimension of the particles 16 may range from about 100 μm to about 1 mm, or they may range from about 200 μm to about 800 μm, preferably they may range from about 250 μm to about 600 μm. The maximum dimension is, for example, about 500 μm. The maximum dimension of the loosely-packed solid particles 34 are substantially uniform. Particles 34 exhibiting a roughly spherical shape and mono-disparity in their size distribution are advantageous for achieving liquefaction. In this way, the size of interstices of adjacent particles 34 are substantially uniform which causes a uniform transport of liquid by capillary force across the liquid retention element. With reference to the expression “maximum dimension”, in case of elongated particles like rods, for example, the maximum dimension is length of the rods. For particles with oval cross section, the maximum dimension is a large dimeter along the major axis. In case the particles are substantially spherical, the maximum dimension corresponds to the diameter.

Preferably, the solid particles 34 have densities between 10 kg/m³ and 20 000 kg/m³, preferably between 1 000 kg/m³ and 4 000 kg/m³. Preferably, the solid particles 34 are made of: silica gel, aerographite, tungsten, ceramics, silica, glass, pearlite, metal such as Al, Fe or mild steel, tobacco or tobacco-derived material. The density and therefore the mass of the particles influence how much energy is required to generate movement and liquefaction. The density of the particles 34 may therefore be adjusted according to the needs, choosing densities between 10 kg/m³ for example by using silica gel or aerographite, to 20,000 kg/m³ by using tungsten or other dense metals. In particular, the preferred particles density is chosen between 1 000 kg/m³ and 4 000 kg/m³ by using for example materials as ceramics, silica, glass or pearlite.

Preferably, the loosely-packed solid particles 34 are stable at least up to a temperature of vaporization of the liquid aerosol forming material, for example up to 350° C. In the context of the present description, a material is “stable” when that the material properties are unchanged or at least do not undergo any significant change. The material properties are, for example, phase (solid, liquid, gas), mechanical properties (strength, hardness etc.), crystal structure, and chemical properties (chemical compositions, chemical structure of constituents etc.).

Preferably, the loosely-packed solid particles 34 or at least the surface of the loosely packed solid particles 34 comprises a material chemically inert to the liquid aerosol forming material. The chemically inert surface may be a chemically inert surface of a solid particle itself. Alternatively, the chemically inert surface may be a chemically inert coating that encapsulates each solid particle. The chemical inertness is herein understood with respect to chemical substances stored in the cartridge as well as chemical substances generated during heating the aerosol forming substrates. The chemically inert coating as well as the particle should withstand at least up to the temperature for vaporization of the aerosol forming material.

The loosely-packed solid particles 34 are configured to retain the aerosol forming liquid in the interstices of particles and their surfaces. In detail, as mentioned above, the particles 34 are agglomerated together by the liquid bridges formed between the particles 34. This phenomenon in turn maintains the liquid in the agglomerated particle structure. The absorbing ability is related to the volume of liquid bridges formed in interstices of adjacent particles, which also determine the agglomeration force of particles 34.

Because the loosely-packed solid particles 34 in the liquid permeable pouch 32 are not rigidly interconnected, they may be separated by, for example, dispersing them into a liquid. This may be advantageous in terms of reusability of the cartridge 14 because individually separated particles 34 can be effectively cleaned by any cleaning methods established for small particles.

The vibrating element 22 is preferably arranged in the device 12 in order to provide a more simple structure for the cartridge 14. However, the vibrating element 22 may be arranged in a variant in the cartridge 14. The vibrating element 22 is configured to generate excitation waves inside the wick element 18 to create or enhance wicking from the storage compartment 16 to the heater 20. The excitation waves are preferably infrasonic, ultrasonic or sonic waves. The vibrating element 22 is configured to generate said excitation waves with an excitation frequency comprised between 0.5 Hz and 60 KHz. The excitation waves have an amplitude sufficiently large to cause structural reorganization of solid particles 34 contained in the liquid permeable pouch 32. In particular, the vibrating element 22 is configured to generate excitation waves when the heater 20 is heating the liquid aerosol forming material to evaporate it. In other words, the heater 20 is operated simultaneously with the vibrating element 20.

The vibrating element 22 is made of one or several transducer(s). Each transducer is configured to convert the electrical electricity provide by the power supply 24 in acoustic waves. The vibrating element 22 is arranged adjacent to the wick body. In particular, the vibrating element 22 is arranged adjacent to the external surface of the liquid permeable pouch 32. On the example of FIG. 2, two transducers are arranged on opposite sides of the wick body.

In a variant, more than two transducers are arranged around the wick body. Advantageously, the transducers are arranged circumferentially around the wick body and preferably distributed evenly around the wick body, with equal angle intervals between them.

When the vibrating element 22 arranged near the wick element 18 is not generating any vibrations, the solid particles 34 agglomerate together thanks to the presence of the liquid aerosol forming material. In such an agglomeration of solid particles, wicking rate is relatively low because the hydraulic diameters of capillary channels defined by the solid particles are small.

When the vibrating element 22 generates exciting waves, represented by symbol A on FIG. 2, these waves force the particles 34 to oscillate and cause liquefaction of the agglomeration. The hydraulic diameters of the capillary channels defined by the particles 34 tend to become larger as a result of liquefaction, allowing for enhanced liquid flow through the capillary channels of the wick body.

The liquid permeable pouch 32 is preferably at least partially wrapped in an impermeable wrapper. The wrapper is configured to be removed before operating the system 10 to generate aerosol. The wrapper prevents unwanted leakage of the liquid when the system 10 is not in use.

In a variant, the wrapper forms an opening while operating the system to generate aerosol. In particular, the wrapper may be formed of a material that only enables fluid flow once the wicking element 18 is brought in contact with the heater 30. The heat may induce a change in wettability or the wrapper may be a wax, melting at elevated temperatures.

### DESCRIPTION OF A SECOND EMBODIMENT OF THE INVENTION

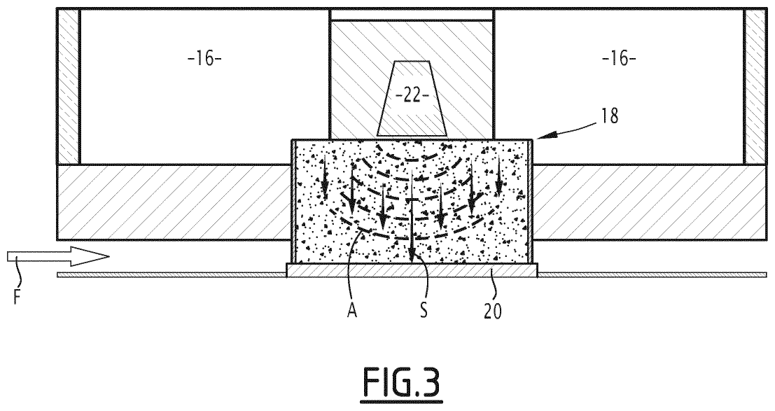

FIG. 3 shows the wick element 18 of an aerosol generating system according to a second embodiment of the invention.

The aerosol generating system according to the second embodiment is similar to the aerosol generating system 10 according to the first embodiment explained above except the features described below.

The wick element 18 forms a wick body. The wick body is here a porous solid monolithic element. By “monolithic”, it is understood a rigid single piece of solid material. In particular, as visible on FIG. 3, the wick body is here formed by a porous solid element made of porous ceramic material. The porous ceramic material is preferably aluminum oxide, zirconia, or silicon nitride.

There is no need of liquid permeable pouch 32 in this embodiment, the wick body being monolithic.

As visible on FIG. 3, the vibrating element 22 is made here of a single focused transducer arranged on top of the wick element 18, inside the storage compartment 16.

The transducer enables to provide an excitation waves focused in a specific direction which generates the acoustic streaming flow of the liquid having a net forward flow velocity in said direction within the wick element 18, as represented by the arrows S on FIG. 3, leading to an increase in the wicking rate in the desired direction, typically from the storage compartment 16 toward the heater 20, in a controlled manner.

The frequency of the excitation waves may be in the range of 10 Hz to 60 KHz, and more preferably between 20 KHz to 40 KHz. Ultrasonic excitation may be achieved even if excitation frequencies below 20 KHz are used due to the complex porous structure interaction with the waves resulting in higher order harmonics being generated in the fluid.

### DESCRIPTION OF A THIRD EMBODIMENT OF THE INVENTION

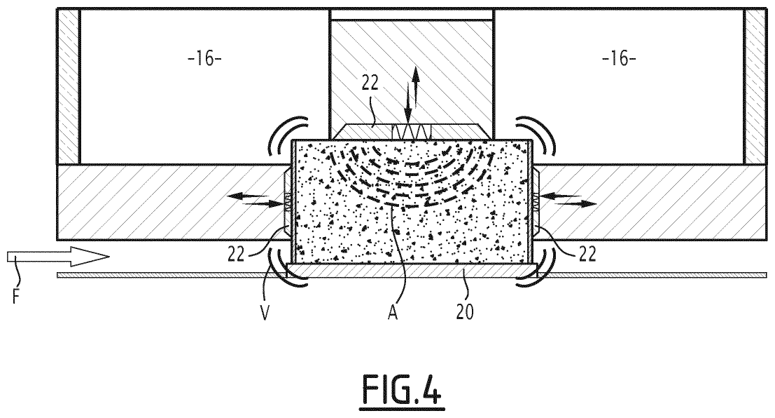

FIG. 4 shows the wick element 18 of an aerosol generating system according to a third embodiment of the invention.

The aerosol generating system according to the third embodiment is similar to the aerosol generating system according to the second embodiment explained above except the features described below.

The vibrating element 22 is here made of a single or several transducers arranged on the sides of the wick element 18. The vibrating element 22 forms an omnidirectional source of excitation waves. The wick body is therefore excited in a general manner, with no specific focused direction of excitation.

This causes the vibration of the whole wick body as represented by symbol V on FIG. 4. The excitation and the vibration of the entire wick body results in increased friction and heat generation reducing viscosity and increasing liquid flow.

In a variant (not shown here), the wick body may be formed by a liquid permeable pouch 32 filled with a liquid retention medium. The liquid retention medium comprises loosely-packed solid particles 34.

### DESCRIPTION OF A FOURTH EMBODIMENT OF THE INVENTION

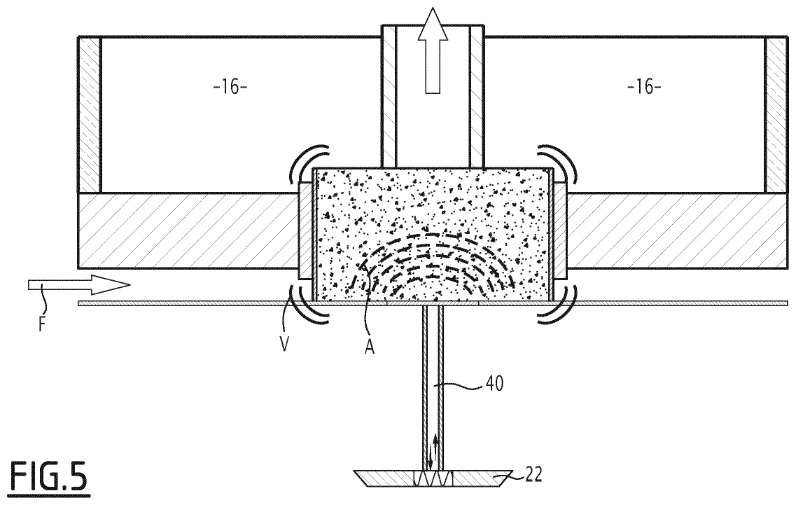

FIG. 5 shows the wick element 18 of an aerosol generating system according to a fourth embodiment of the invention.

The aerosol generating system according to the fourth embodiment is similar to the aerosol generating system according to the third embodiment explained above except the features described below.

The vibrating element 22 is disposed away from the wick body. The aerosol generating system comprises a connecting element 40 connecting the vibrating element 22 and the wick body. The connecting element 40 is configured to transmit excitation waves from the vibrating element 22 to the wick body. The connecting element 40 is for example a piston or a rod.

In this embodiment, the excitation source does not need to be in direct contact with the wick body. The vibrating element 22 may be disposed at any location in the device 12, while enabling an efficient excitation of the wick body through the connecting element 40.

In a variant (not shown here), the wick body may be formed by a liquid permeable pouch 32 filled with a liquid retention medium. The liquid retention medium comprises loosely-packed solid particles 34.

### DESCRIPTION OF A FIFTH EMBODIMENT OF THE INVENTION

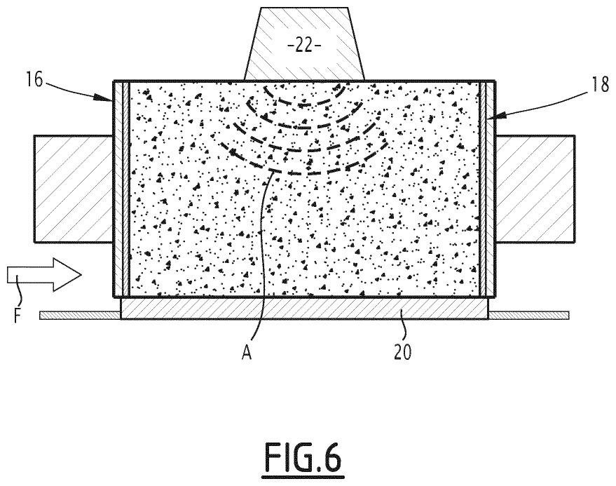

FIG. 6 shows the wick element 18 of an aerosol generating system according to a fifth embodiment of the invention.

The aerosol generating system according to the fifth embodiment is similar to the aerosol generating system according to the embodiments explained above except the features described below.

In the previous embodiments, as visible on FIGS. 2 to 5, the storage compartment 16 and the wick element 18 are separated. Here, as visible on FIG. 6, the storage compartment 16 and the wick element 18 are combined in a same housing.

Here, the housing 16, 18 comprises a porous solid monolithic element which retains the liquid aerosol-forming material. The housing acts as a reservoir and as a wick.

In a variant (not shown here), the housing 16, 18 may comprise a group of flowable solid particles.

### OTHER EMBODIMENTS OF THE INVENTION

It will be apparent to those skilled in the art that other embodiments may be carried out in various ways by combining the previous embodiments.

For example, the aerosol generating system may comprise a focused transducer arranged on top of the wick element 18 and a remote vibrating element 22 connected to the wick body by a connecting element 40.

1. An aerosol generating system comprising:
a storage compartment comprising a liquid aerosol-forming material;
a wick element forming a wick body and arranged in fluid communication with the storage compartment; the wick body being formed by:
a group of flowable solid particles; or
a porous solid monolithic element;
a heater; and
a vibrating element configured to generate excitation waves inside the wick element to create or enhance wicking from the storage compartment to the heater.

2. The aerosol generating system according to claim 1, wherein said excitation waves are infrasonic, ultrasonic or sonic waves.

3. The aerosol generating system according to claim 1, wherein the vibrating element is configured to generate said excitation waves with an excitation frequency comprised between 0.5 Hz and 60 KHz.

4. The aerosol generating system according to claim 1, wherein the vibrating element is arranged adjacent to the wick body.

5. The aerosol generating system according to claim 1, further comprising a connecting element connecting the vibrating element and the wick body, and configured to transmit excitation waves from the vibrating element to the wick body.

6. The aerosol generating system according to claim 1, wherein the vibrating element forms a unidirectional source of excitation waves.

7. The aerosol generating system according to claim 1, wherein the vibrating element forms an omnidirectional source of excitation waves.

8. The aerosol generating system according to claim 1, wherein the vibrating element comprises at least two vibrating elements.

9. The aerosol generating system according to claim 1, wherein the wick body is a group of flowable solid particles, the group of flowable solid particles formed of a liquid permeable pouch having an interior volume and loosely-packed solid particles stored within the interior volume of the liquid permeable pouch.

10. The aerosol generating system according to claim 9, wherein the storage compartment is formed at least partially by the liquid permeable pouch, the liquid aerosol forming material retained inside the pouch in the interstices of the solid particles and/or on surfaces of the solid particles.

11. The aerosol generating system according to claim 9, wherein the liquid permeable pouch is at least partially wrapped in an impermeable wrapper.

12. The aerosol generating system according to claim 11, wherein the wrapper is configured to be removed before operating the system to generate aerosol or to form an opening while operating the system to generate aerosol.

13. The aerosol generating system according to claim 1, wherein the wick body is a porous solid monolithic element made of porous ceramic material.

14. The aerosol generating system according to claim 13, wherein the porous ceramic material is aluminum oxide, zirconia, or silicon nitride.

15. The aerosol generating system according to claim 13, wherein the storage compartment and the wick element are combined in a same housing.

16. A method of operating an aerosol generating system comprising steps of:
providing an aerosol generating system according to claim 1; and
operating simultaneously the heater to generate heat for evaporating the liquid aerosol forming material delivered from the storage compartment to a surface of the heater through the wick element and the vibrating element to generate excitation waves inside the wick element.

17. The aerosol generating system according to claim 2, wherein the vibrating element is configured to generate said excitation waves with an excitation frequency comprised between 0.5 Hz and 60 kHz.

18. The aerosol generating system according to claim 8, wherein the two vibrating elements are distributed evenly around the wick body.

19. The aerosol generating system according to claim 10, wherein the liquid permeable pouch is at least partially wrapped in an impermeable wrapper.

20. The aerosol generating system according to claim 14, wherein the storage compartment and the wick element are combined in a same housing.
